(19) United States
(12) Patent Application Publication
(10) Pub. No.: US 2019/0004378 A1
(43) Pub. Date: Jan. 3, 2019

(54) DISPLAY SUBSTRATE AND DISPLAY PANEL

(71) Applicants: HKC CORPORATION LIMITED, Shenzhen, Guangdong (CN); CHONGQING HKC OPTOELECTRONICS TECHNOLOGY CO., LTD., Jieshi, Chongqing (CN)

(72) Inventor: Yu-jen CHEN, Jieshi (CN)

(73) Assignees: HKC Corporation Limited, Shenzhen, Guangdong (CN); Chongqing HKC Optoelectronics Technology Co., Ltd., Jeshi, Chongqing (CN)

(21) Appl. No.: 15/744,275

(22) PCT Filed: Jul. 27, 2017
(86) PCT No.: PCT/CN2017/094560

§ 371 Date: Jan. 12, 2018

(30) Foreign Application Priority Data
Mar. 13, 2017 (CN) 201710145235.3

(51) Int. Cl. G02F 1/1337; G02F 1/1335

(52) U.S. Cl. CPC G02F 1/133723; G02F 1/133512

(57) ABSTRACT

A display substrate and a display panel are provided. The display substrate includes: a substrate; a black matrix layer disposed at a side of the substrate and an alignment layer. The substrate includes a display region. The black matrix layer includes a black matrix frame arranged to surround the display region. The black matrix frame is provided with a groove. The groove surrounds the display region. The alignment layer is coated within the display region.

### TECHNICAL FIELD

The present disclosure relates to a display substrate and a display panel.

### BACKGROUND

A liquid crystal display panel generally includes an array substrate, a color filter substrate, and a liquid crystal layer located therebetween. Typically, an alignment layer is formed on the array substrate and the color film substrate separately. The alignment layer causes liquid crystals of the liquid crystal layer to have a pre-deflection angle to facilitate control of the liquid crystals for display. The material of the alignment layer is usually polyimide (PI).

When the polyimide is coated on the color filter substrate or the array substrate, the polyimide flows to the position where the perimeter sealant is disposed, which affects the quality of the formed liquid crystal cell, and is liable to cause the perimeter sealant to fall off and affects the display.

### SUMMARY

The present disclosure provides a display substrate and a display panel to prevent polyimide from flowing to a position of a perimeter sealant so that a formed alignment layer and the perimeter sealant do not overlap and thereby quality of a liquid crystal cell is not affected.

According to a first aspect, an embodiment of the present disclosure provides a display substrate. The display substrate includes: a substrate having a display region, a black matrix layer disposed on the substrate, and an alignment layer.

The black matrix layer is provided with a groove surrounding the display region, and the alignment layer is coated within the display region.

According to a second aspect, an embodiment of the present disclosure further provides a display panel. The display panel includes: a first baseplate, a second baseplate opposite to the first baseplate. The second baseplate is provided with a metal shielding layer.

The first baseplate includes: a substrate having a display region, a black matrix layer disposed on the substrate, and an alignment layer.

The black matrix layer is provided with a groove surrounding the display region, and the alignment layer is coated within the display region. A vertical projection of the groove on the second baseplate is within a vertical projection of the metal shielding layer on the second baseplate.

According to a third aspect, an embodiment of the present disclosure further provides another display panel. The display panel includes: a first baseplate, a second baseplate opposite to the first baseplate, and a liquid crystal layer. The second baseplate is bonded to the first baseplate by a perimeter sealant to form a sealed space. The liquid crystal layer is disposed in the sealed space.

A black matrix layer is provided on the first baseplate and in the sealed space, the black matrix layer includes a first region and a second region surrounding the first region, the first region of the black matrix layer has a transparent region and an opaque region, the second region is opaque and provided with a groove surrounding the first region, an alignment layer is provided on the first region of the black matrix layer.

The second baseplate has a third region and a fourth region surrounding the third region. The third region corresponds to the second region of the black matrix layer and is provided with a plurality of color filters. The fourth region corresponds to the second region of the black matrix layer and is provided with a metal shielding layer.

A vertical projection of the groove on the second baseplate is within a vertical projection of the metal shielding layer on the second baseplate.

### BRIEF DESCRIPTION OF DRAWINGS

Exemplary embodiments of the present disclosure will be described in detail below with reference to the accompanying drawings so that those of ordinary skill in the art will more clearly understand the above and other features of the present disclosure.

FIG. 1A is a schematic top view of a display substrate according to an embodiment of the present disclosure;

FIG. 1B is a schematic sectional view taken along the line A-A in FIG. 1A;

FIG. 1C is a schematic sectional view of another display substrate according to an embodiment of the present disclosure;

FIG. 2A is a schematic sectional view of a display panel according to an embodiment of the present disclosure;

FIG. 2B is a schematic top view of a first baseplate according to an embodiment of the present disclosure;

FIG. 2C is a schematic top view of a second baseplate according to an embodiment of the present disclosure;

FIG. 3 is a schematic structural view of a display device according to an embodiment of the present disclosure;

FIG. 4 is a schematic structural view of another display panel;

FIG. 5 is a top view of a first baseplate of the display panel in FIG. 4; and

FIG. 6 is a top view of a second baseplate of the display panel in FIG. 4.

### DETAILED DESCRIPTION

The present disclosure will be described in further detail with reference to the accompanying drawings and embodiments. It is to be understood that the specific embodiments described herein are intended to illustrate but not to limit the present disclosure. It is to be noted that, for the sake of convenience of description, only parts related to the present disclosure and not all structures are shown in the accompanying drawings. If not in conflict, the following embodiments and the features in the embodiments may be freely combined with each other.

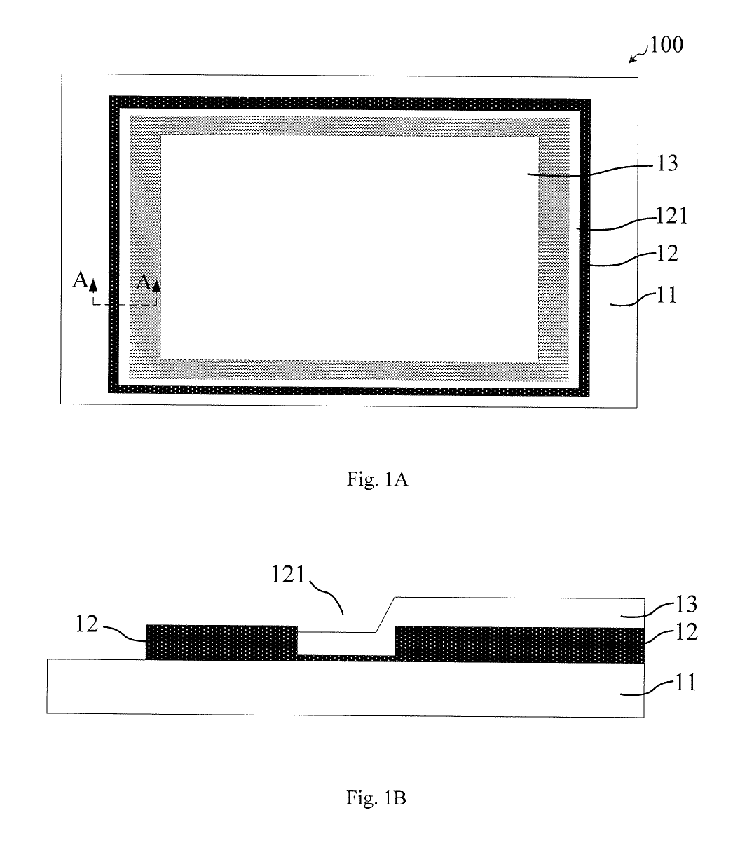

FIG. 1A is a schematic top view of a display substrate according to an embodiment of the present disclosure. FIG. 1B is a schematic sectional view taken along the line A-A in FIG. 1A. With reference to FIGS. 1A and 1B, a display substrate 100 provided by an embodiment of the present disclosure includes: a substrate 11, an alignment layer 13, and a black matrix layer 12 disposed on a side of the substrate 11.

The substrate 11 includes a display region (a region enclosed by a dashed box in FIG. 1A). The black matrix layer 12 includes a black matrix frame arranged to surround the display region. The black matrix frame is provided with a groove 121. The groove 121 surrounds the display region. The alignment layer 13 is coated on the display region.

In embodiments of the present disclosure, after the black matrix layer 12 is formed on the substrate 11, a side of the black matrix layer 12 facing away from the substrate is coated with a PI liquid to form the alignment layer 13. During the coating of the PI liquid within the display region, the PI liquid spreads and flows into the groove 121. The groove 121 blocks the PI liquid, so that the PI liquid does not flow to a region on the display substrate where a perimeter sealant is provided, and the formed alignment layer 13 does not overlap with the perimeter sealant, so the quality of a liquid crystal cell subsequently formed by the display substrate 100 is high, thus improving the display effect of the display panel formed by the display substrate 100. The perimeter sealant is typically disposed around the edge of the display substrate. The groove 121 surrounds the display region, and thus ensures that the PI liquid does not flow to the region where the perimeter sealant is provided.

Furthermore, in embodiments of the present disclosure, the alignment layer 13 extends into the groove 121. That is, a region coated with the PI liquid includes the region where the groove 121 is located and the display region. In this case, the groove 121 can prevent the PI liquid from flowing to regions other than the region where the groove 121 is located and the display region. The formed alignment layer does not overlap with the perimeter sealant, and the quality of the liquid crystal cell subsequently formed using the display substrate 100 provided by embodiments of the present disclosure is high.

FIG. 1C is a schematic sectional view of another display substrate according to an embodiment of the present disclosure. With reference to FIG. 1C, unlike the display substrate shown in FIG. 1B, the groove 121 runs through the black matrix frame in the display substrate. The groove 121 runs through the black matrix frame, so in the case where the thickness of the black matrix frame is constant, the depth of the groove 121 is increased, and the groove 121 can block the further spreading of the PI liquid.

If the width of the groove is set to a too small value, the flowing of the PI liquid cannot be effectively blocked, and the formed alignment layer 13 will affect the bezel. When the width of the groove is set to a too large value, the groove will occupy more area at the edge. With continued reference to FIG. 1C, in the present embodiment, the width d1 of the groove 121 is 30 um to 2000 um, such that the area of the black matrix frame occupied by the groove 121 is minimum and it is easy to implement narrow bezel in addition to ensuring that the groove 121 can effectively block the flowing of the PI liquid.

Continuing to refer to FIG. 1C, in the present embodiment, a depth d2 of the groove 121 is 0.1 um to 2 um in a direction perpendicular to the substrate 11. The depth d2 of the groove 121 is typically about 1 um. In practice, the depth d2 of the groove 121 may be adjusted in accordance with the thickness of the black matrix frame and the thickness of the alignment layer 13 to be formed. Typically, the depth d2 of the groove 121 should be equal to or greater than the thickness of the alignment layer 13 to be formed.

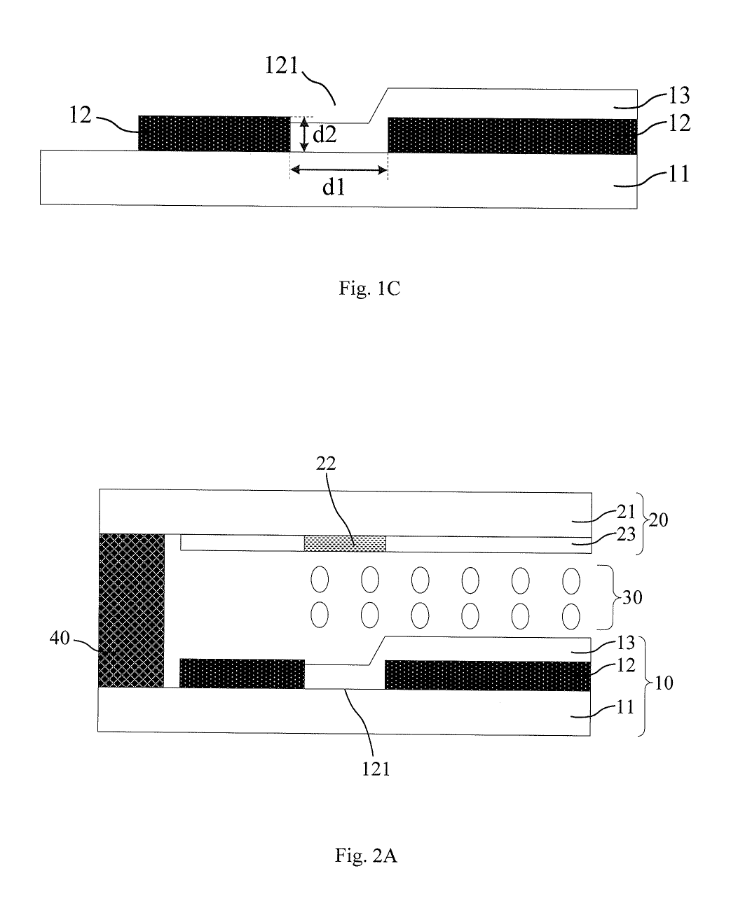

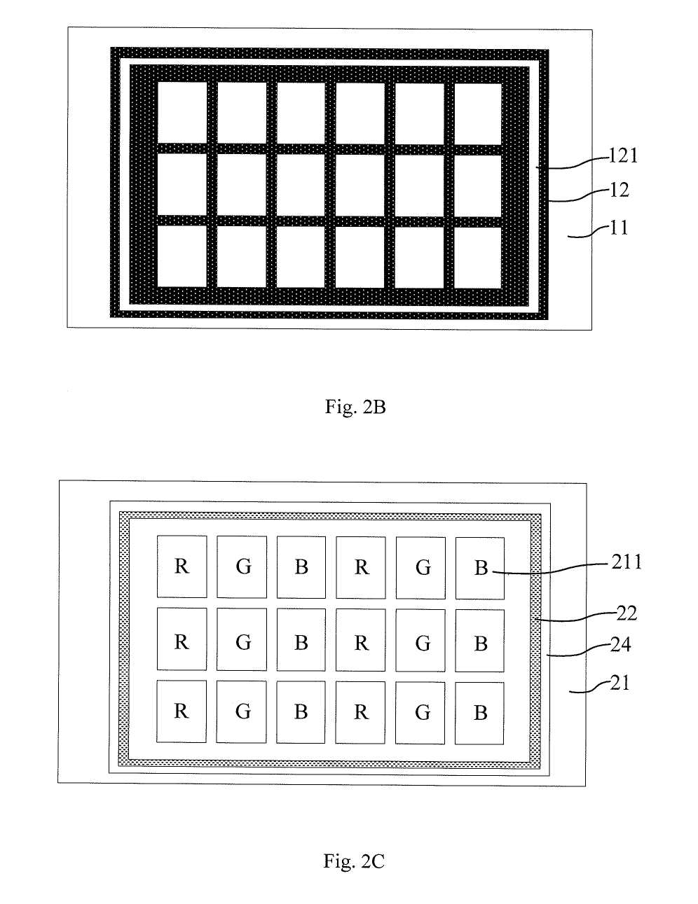

An embodiment of the present disclosure further provides a display panel. FIG. 2A is a schematic sectional view of the display panel according to an embodiment of the present disclosure. Referring to FIG. 2A, the display panel includes: a first baseplate 10, which is the display substrate 100 provided by any embodiment of the present disclosure, a second baseplate 20, which is arranged opposite to the first baseplate 10, and multiple liquid crystals 30, disposed between the first baseplate 10 and the second baseplate 10.

A metal shielding layer 22 is provided on the second baseplate 20. For example, the metal shielding layer 22 is disposed on a substrate 21 of the second baseplate. An insulation layer 23 insulates the metal shielding layer 22 from other layers. The metal shielding layer 22 is disposed opposite to the groove 121, and a vertical projection of the groove 121 on the second baseplate 20 is within a vertical projection of the metal shielding layer 22 on the second baseplate 20. In the present embodiment, the metal shielding layer 22 is provided on the second baseplate 20 to prevent light leak when the groove 121 runs through the black matrix frame. It should be noted that, in the present embodiment, the metal shielding layer 22 may be provided on any film of the second baseplate 20 as long as the metal shielding layer is provided in correspondence with the groove 121.

In embodiments of the present disclosure, the material of the metal shielding layer 22 may be molybdenum, copper, aluminum, molybdenum-copper alloy or molybdenum-aluminum alloy.

Furthermore, continuing to refer to FIG. 2A, the display panel provided by the embodiments further includes a perimeter sealant 40 disposed between the first baseplate 10 and the second baseplate 20. The perimeter sealant 40 is arranged to surround the black matrix layer 12. The first baseplate 10 and the second baseplate 20 are bonded by the perimeter sealant 40 to form a sealed space. The liquid crystal 30 is disposed in the sealed space, so that the liquid crystals 30 cannot leak and external pollutants cannot go into the LCD cell.

FIG. 2B is a schematic top view of a first baseplate according to an embodiment of the present disclosure, and FIG. 2C is a schematic top view of a second baseplate according to an embodiment of the present disclosure. On the basis of the display panel provided in any of the embodiments of the present disclosure, a color filter is further provided on the second baseplate 20 in the display panel. It can be seen that a color filter group 211 is provided on the color filter, and the photoresist 211 includes a red photoresist (R), a green photoresist (G), and a blue photoresist (B). The color filter is located in a region opposite to the display region. After the first baseplate 10 and the second baseplate 20 are bonded and sealed with the perimeter sealant 40, the region enclosed by the black matrix layer 12 is opposite to the region where the color filter is provided. It should be noted that FIG. 2B is just one example of an arrangement of the color filters, and in other embodiments of the present disclosure, the arrangement of the color filters may vary.

In the display panel provided by embodiments of the present disclosure, after the first baseplate 10 and the second baseplate 20 are bonded, the region enclosed by the black matrix layer 12 on the first baseplate 10 is opposite to the color filter on the second baseplate 20. It can be seen that a groove 24 is formed at a region 21 of the second baseplate 20 corresponding to the black matrix frame on the first baseplate 10. When the second baseplate 20 is coated with PI liquid, the groove 24 blocks the flowing of the PI liquid. In the present embodiment, the black matrix layer 20 is disposed on the first baseplate 10, the color filter is disposed on the second baseplate 20, and the black matrix frame of the first baseplate 10 is provided with the groove 121, such that when the first baseplate 10 and the second baseplate 20 are coated with PI liquid, both the first baseplate 10 and the second baseplate 20 do not require a barricade. In an existing art, the black matrix layer 12 and the color filter are formed at the same layer, so it is required to additionally arrange a barricade for preventing the flowing of the PI liquid, or to arrange more spacer columns serving as the barricade. The display panel provided in the present embodiment eliminates the need for barricades on both the substrates (the first baseplate and the second baseplate), improves the display effect of the display panel, reduces the material and the processing step of the display panel, and reduces the production costs.

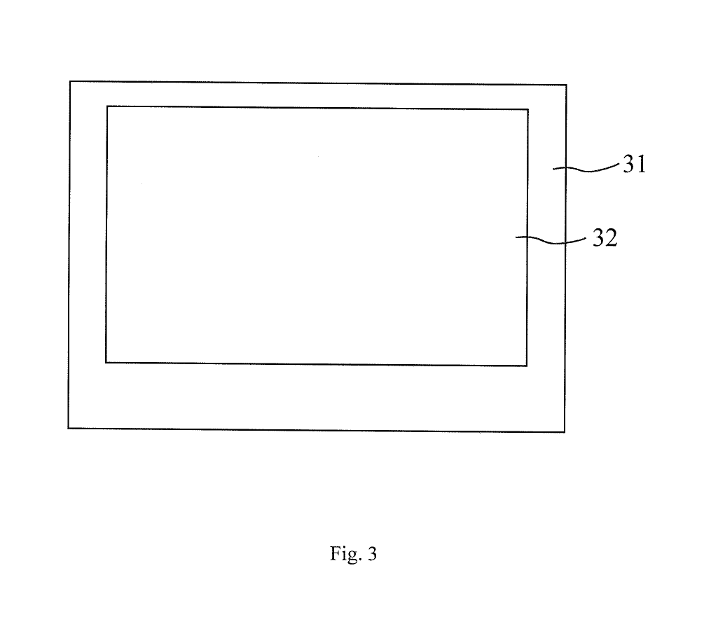

An embodiment of the present disclosure further provides a display device. Exemplarily, FIG. 3 is a schematic structural view of a display device according to an embodiment of the present disclosure. With reference to FIG. 3, a display device 31 includes a display panel 32 provided by any embodiment of the present disclosure. In the display device 31, the black matrix layer is disposed on the first baseplate, the color filter is disposed on the second baseplate, and a groove capable of preventing the PI liquid from spreading is disposed at the black matrix frame around the display region on the first baseplate. The formed alignment layer do not coincide with the position where the perimeter sealant is provided on the display device, the barricades are omitted on both the first baseplate and the second baseplate, thereby not only improving the display effect of the display device but also saving the material and processing steps of the display panel and reducing the production costs.

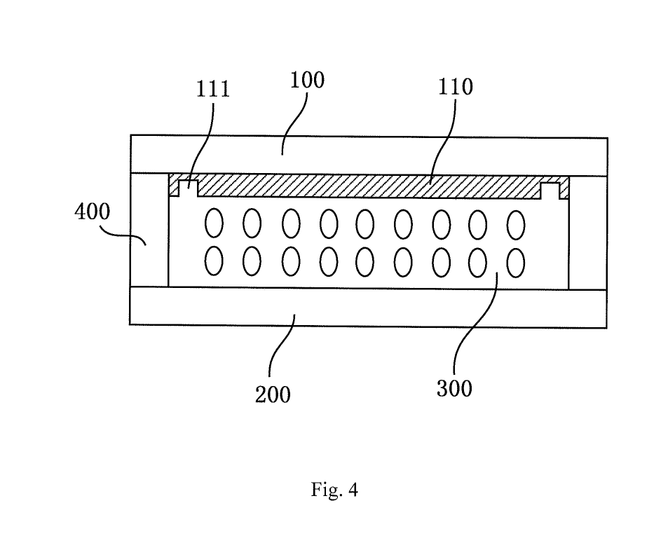

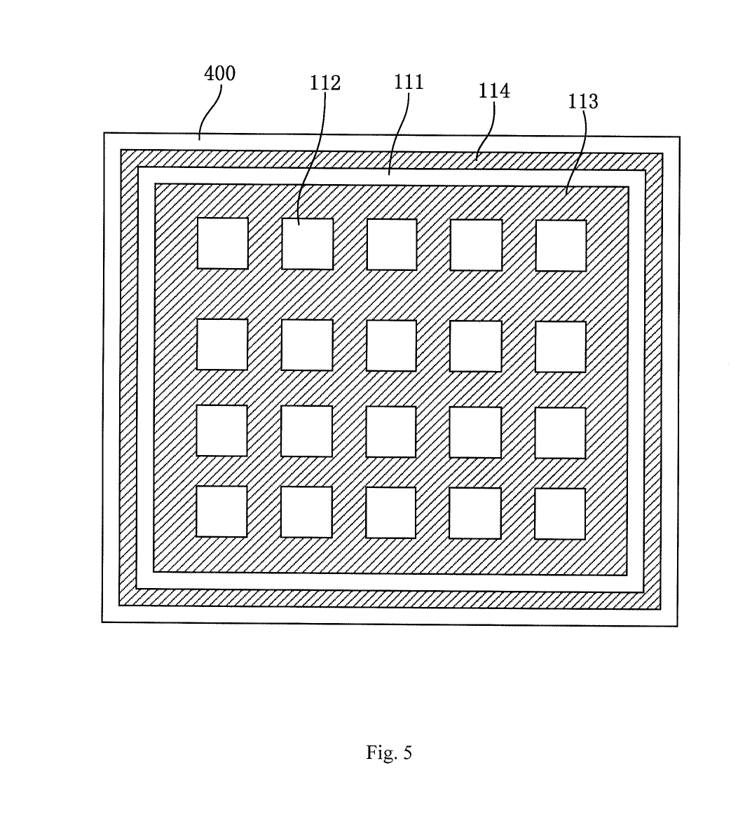

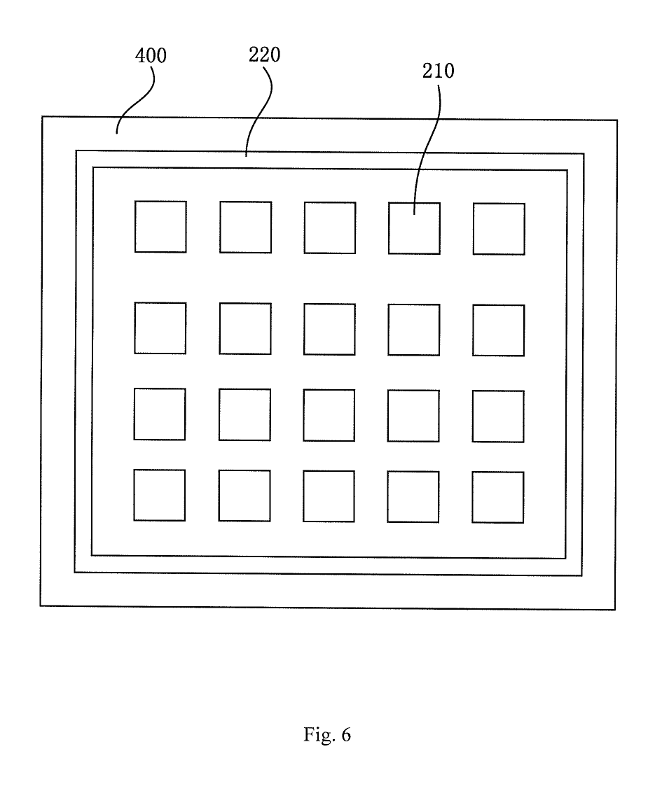

FIG. 4 is a schematic structural view of another display panel, FIG. 5 is a top view of a first baseplate of the display panel in FIG. 4, and FIG. 6 is a top view of a second baseplate of the display panel in FIG. 4. As shown in FIGS. 4 to 6, the display panel includes a first baseplate 100, a second baseplate 200, and a liquid crystal layer 300 disposed between the first baseplate 100 and the second baseplate 200. The first baseplate 100 and the second baseplate 200 are opposite to each other. The second baseplate 200 is bonded to the first baseplate 100 by a perimeter sealant 400 to produce a sealed space. The liquid crystal layer 300 is disposed in the sealed space.

A black matrix layer 110 is provided on the first baseplate 100 and in the sealed space. The black matrix layer 110 includes a first region and a second region surrounding the first region. The first region of the black matrix layer has a transparent region 112 and an opaque region 113. The second region includes an opaque region 114 and a groove 111. The groove 111 encloses the first region. An alignment layer is provided on the first region of the black matrix layer.

The second baseplate 200 has a third region and a fourth region surrounding the third region. The third region corresponds to the second region of the black matrix and is provided with a plurality of color filters 210. The fourth region corresponds to the second region of the black matrix and is provided with a metal shielding layer 220.

A vertical projection of the groove 111 on the second baseplate 200 is within a vertical projection of the metal shielding layer 220 on the second baseplate 200.

Optionally, the alignment layer extends into the groove.

Optionally, the groove is disposed throughout the black matrix layer.

Optionally, a width of the groove is 30 um to 2000 um.

Optionally, a depth of the groove is 0.1 um to 2 um.

Optionally, the second baseplate is provided with a thin film transistor layer.

It is to be noted that the foregoing are only preferred embodiments of the present disclosure and the technical principles used therein. It will be understood by those skilled in the art that the present disclosure is not limited to the specific embodiments described herein and that those skilled in the art can make various changes, modifications and substitutions within the scope of the present disclosure. Accordingly, although the present disclosure has been described in more detail by way of the above embodiments, the present disclosure is not limited to the above embodiments, and other equivalent embodiments may be included without departing from the spirit of the present disclosure. The scope of the disclosure is determined by the appended claims.

What is claimed is:

1. A display substrate comprising:
a substrate, comprising a display region;
a black matrix layer, disposed on the substrate; and
an alignment layer;
wherein the black matrix layer is provided with a groove surrounding the display region, and the alignment layer is coated within the display region.

2. The display substrate of claim 1, wherein the alignment layer extends into the groove.

3. The display substrate of claim 1, wherein the groove runs through the black matrix layer.

4. The display substrate of claim 1, wherein a width of the groove is between 30 um and 2000 um.

5. The display substrate of claim 1, wherein a depth of the groove is greater than a thickness of the alignment layer in a direction perpendicular to the substrate.

6. The display substrate of claim 5, wherein the depth of the groove is between 0.1 um and 2 um in the direction perpendicular to the substrate.

7. A display panel, comprising:
a first baseplate; and
a second baseplate, which is opposite to the first baseplate and is provided with a metal shielding layer,
wherein the first baseplate comprises:
a substrate, comprising a display region;
a black matrix layer disposed on the substrate; and
an alignment layer;
wherein the black matrix layer is provided with a groove surrounding the display region, and the alignment layer is coated within the display region,
wherein a vertical projection of the groove on the second baseplate is within a vertical projection of the metal shielding layer on the second baseplate.

8. The display panel of claim 7, wherein the alignment layer extends into the groove.

9. The display panel of claim 7, wherein the groove runs throughthe black matrix layer.

10. The display panel of claim 7, wherein a width of the groove is between 30 um and 2000 um.

11. The display panel of claim 7, wherein a depth of the groove is between 0.1 um and 2 um in a direction perpendicular to the substrate.

12. The display panel of claim 7, wherein a matrial of the metal shielding layer is molybdenum, copper, aluminum, molybdenum-copper alloy, or molybdenum-aluminum alloy.

13. The display panel of claim 7, further comprising a perimeter sealant dispoesd between the first baseplate and the second baseplate and enclosing the black matrix layer.

14. The display panel of claim 7, wherein the second baseplate is provided with a color filter located in a region corresponding to the display region.

15. A display panel, comprising:
a first baseplate;
a second baseplate opposite to the first baseplate, wherein the second baseplate is bonded to the first baseplate by a perimeter sealant to form a sealed space; and
a liquid crystal layer disposed in the sealed space,
wherein a black matrix layer is provided on the first baseplate and in the sealed space, the black matrix layer comprises a first region and a second region surrounding the first region, the first region of the black matrix layer has a transparent region and an opaque region, the second region is opaque and provided with a groove surrounding the first region, an alignment layer is provided on the first region of the black matrix layer,
the second baseplate has a third region and a fourth region surrounding the third region, the third region corresponds to the first region of the black matrix layer and is provided with a plurality of color filters, the fourth region corresponds to the second region of the black matrix layer and is provided with a metal shielding layer,
wherein a vertical projection of the groove on the second baseplate is within a vertical projection of the metal shielding layer on the second baseplate.

16. The display panel of claim 15, wherein the alignment layer extends into the groove.

17. The display panel of claim 15, wherein the groove runs through the black matrix layer.

18. The display panel of claim 15, wherein a width of the groove is between 30 um and 2000 um.

19. The display panel of claim 15, wherein a depth of the groove is between 0.1 um and 2 um.

20. The display panel of claim 15, wherein the second baseplate is provided with a thin film transistor layer.
